(19) United States
(12) Patent Application Publication
(10) Pub. No.: US 2006/0207085 A1
(43) Pub. Date: Sep. 21, 2006

(54) Battery and method for manufacturing same

(75) Inventors: Yugo Nakagawa, Toyohashi-shi (JP); Tomoaki Yamamoto, Kosai-shi (JP); Takashi Maruyama, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 11/376,314

(22) Filed: Mar. 16, 2006

(30) Foreign Application Priority Data
Mar. 16, 2005 (JP) 2005-074837

(51) Int. Cl. H01M 10/04; H01M 2/08; H01M 2/04

(52) U.S. Cl. 29/623.1; 29/623.2; 429/175; 429/185

(57) ABSTRACT

A method is provided for manufacturing a battery having a case where the sites to which high stresses are applied are strongly welded. The case has a closed bottom and an opened top. The cross section of a peripheral wall of the case defining the opened top is substantially polygon, and a thickness of the peripheral wall is thick at middle portion and thin at distal end portions of a side that is longest among sides defining the polygon. The method includes steps of contacting a seal plate against a top surface of the peripheral wall of the case to close the opened top of the case, and scanning and radiating an energy beam along the contacting line between the peripheral wall of the case and the seal plate continuously. The energy beam having large energy is radiated at a position where the peripheral wall is thick and the energy beam having small energy is radiated at positions where the peripheral wall is thin.

### CROSS-REFERENCE TO RELATED APPLICATION

This application claims priority to Japanese Patent Application No. 2005-074837, filed on Mar. 16, 2005, the contents of which are hereby incorporated by reference into the present application.

### BACKGROUND OF THE INVENTION

1. Field of the Invention

The present invention relates to a battery and a method for manufacturing same. The term “battery” as employed in the present specification generally describes a device for supplying electric power by using accumulated energy and includes various secondary batteries or capacitors.

2. Description of the Related Art

Batteries of one type are known in which an electrode unit and an electrolyte are accommodated in a metal case comprising a closed bottom and an opened top, and the opened top of the case is closed with a seal plate.

In a representative battery case, the cross-sectional shape of the peripheral wall defining the opened top is a polygon, most often a rectangle. When the cross-sectional shape of the peripheral wall is a rectangle, a rectangular seal plate is used.

Batteries of a system in which the opened top of the case with a rectangular cross section is closed with a seal plate are disclosed in Japanese Patent Applications Laid-open No. 9-7560, 11-90657, 2002-289153, and 2002-224868.

The batteries described in Japanese Patent Applications Laid-open No. 9-7560 and 11-90657 use rectangular seal plates, inserted into the opened top of the case, with a rectangular cross section. An energy beam is radiated along a boundary line of the peripheral wall defining the opened top of the case, and the seal plate inserted thereinto, and the contacting portions of the case and seal plate are welded. The energy beam is radiated from the direction substantially parallel to the peripheral wall defining the opened top of the case.

The battery described in Japanese Patent Application Laid-open No. 2002-224868 uses a seal plate having an outline equal to the outline of the cross section of the case with a rectangular cross section. The seal plate is disposed so as to be in contact with the top surface of the peripheral wall defining the opened top. An energy beam is radiated along the line where the top surface of the peripheral wall and the lower surface of the seal plate are in contact with each other, and the contacting portions of the case and seal plate are welded. The energy beam is radiated from the direction substantially perpendicular to the peripheral wall defining the opened top of the case.

When the internal pressure of the battery rises for any reason, stresses are applied to the welds of the case and seal plate. In this case, a high stress tends to be applied to the middle portion of each side of the peripheral wall with a polygonal cross section. In particular, a high stress tends to be applied to the middle portion of the longest side of a plurality of sides defining the polygon. For example, when a case in the form of a rectangular parallelepiped having a rectangular open section is used, the middle sections of a pair of wide peripheral walls are easily deformed by the increase in internal pressure, so as to protrude greatly to the outside.

For this reason, stresses are easily concentrated in the weld of the peripheral wall in the middle portions of the longest sides, of a plurality of sides defining the polygon, and the seal plate facing the peripheral wall. The concentration of stresses creates a risk of defects, such as cracks, appearing in the welded site. When a case with a polygonal cross section and a seal plate are welded using an energy beam such as a laser beam, the welding strength of the site where high stresses are applied has to be increased.

### BRIEF SUMMARY OF THE INVENTION

The present invention provides a method for strongly welding the portions upon which large stresses act by welding a case and a seal plate by irradiating an energy beam from the side of the case with a polygonal cross section.

The present invention also provides a battery having a case in which the portions upon which large stresses act are strongly welded.

A method of manufacturing a battery of the invention includes a step of installing an electrode unit within a case having a closed bottom and an opened top. The cross section of a peripheral wall defining the opened top of the case is substantially polygon, and a thickness of the peripheral wall is thick at middle portion and thin at distal end portions of a side that is longest among sides defining the polygon. The method of the invention further includes steps of contacting a seal plate against a top surface of the peripheral wall of the case to close the opened top of the case; and scanning and radiating an energy beam along the contacting line between the peripheral wall of the case and the seal plate continuously. The energy beam having large energy is radiated at a position where the peripheral wall is thick and the energy beam having small energy is radiated at positions where the peripheral wall is thin.

The electrode unit as referred to in the present specification is a unit comprising at least one positive electrode and at least one negative electrode and having a difference in electric potential generated therebetween.

The battery as referred to in the present specification is a cell producing an electric potential difference between the positive and negative electrodes by a chemical reaction or a device comprising, e.g., a capacitor accumulating electric energy due to polarization of a dielectric, and no limitation is placed on the electricity accumulation mechanism of the battery. Representative examples of devices included in the term “battery” are a nickel-metal hydride secondary battery, a lithium ion secondary battery, other secondary batteries, or a capacitor having an electric double layer.

One, or a plurality of electrode units, is accommodated in the case. A device, in which a plurality of electrode units is accommodated, in an electrically connected state thereof; in one case is also a battery.

A case in the form of a rectangular parallelepiped or cube having a rectangular or square open section is a case of a typical shape. If the opened top of the case is sealed with the seal plate, the inner space of the case is shielded from the atmosphere.

With the method for manufacturing a battery in accordance with the present invention, the contacting surface of the upper surface of the peripheral wall of the case and the lower surface of the seal plate is irradiated with an energy beam to weld the two. During welding, the energy beam is radiated from the side of the case.

With the above-described method, a case is used in which the thickness of at least the longest side is large in the middle portion and small at both ends. As a result, the peripheral wall constituting the long side is prevented from deforming significantly when the pressure inside the case rises. In the case of a typical shape, the middle portion of the peripheral wall defining the long side has the largest thickness, and the thickness decreases gradually toward both ends.

With the present method, the energy level of the energy beam changes so as to correspond to changes in the thickness of the peripheral wall. When the middle portion with a large wall thickness is irradiated, an energy beam having a high energy level is radiated. When the end portions with a small wall thickness are irradiated, an energy beam having a low energy level is radiated. The depth of the weld is changed by changing the energy level of the energy beam. In the middle portion where the wall thickness is large, the weld is deep and strongly welded. In the end portions where the wall thickness is small, the weld is shallow and weakly welded.

When the internal pressure of the battery rises, a strong stress is easily applied to the middle portion of at least the longest side. With the present manufacturing method, the welding strength of the middle portion onto which high stresses easily act is increased. Because strong welding is performed even if a strong stress is applied to the middle portion of the longest side, cracks, etc., do not occur in the weld. With the present manufacturing method, a battery excelling in pressure resistance during increase in internal pressure can be manufactured. Furthermore, the efficiency of heat provided to the case and seal plate during welding is maintained substantially uniformly over the entire perimeter, regardless of the change in the thickness of the peripheral wall of the case. As a result, the occurrence of local welding defects (for example, blowholes, pits, porosity, etc.) in the welding site of the case and seal plate can be inhibited.

A battery developed by the present invention includes an electrode unit; a case installing the electrode unit, and having a closed bottom and an opened top. The cross section of a peripheral wall defining the opened top is substantially polygon, and a thickness of the peripheral wall is thick at middle portion and thin at distal end portions of a side that is longest among sides defining the polygon. The battery also includes a seal plate welded to a top surface of the peripheral wall of the case. The welded depth between the peripheral wall of the case and the seal plate is deep at a position where the peripheral wall is thick and shallow at positions where the peripheral wall is thin. This battery excels in pressure resistance during increase in internal pressure. Cracks etc. do not occur in the weld even if the internal pressure of the battery rises.

### BRIEF DESCRIPTION OF DRAWINGS

FIG. 1 is a perspective view illustrating schematically the configuration of a battery (nickel—metal hydride secondary battery) of an embodiment of the present invention.

FIG. 2 is a block diagram illustrating schematically an example of the laser welding apparatus preferred for implementing the present invention.

FIG. 3 is an explanatory drawing illustrating schematically the welding process of an embodiment of the present invention.

FIG. 4 is a graph illustrating the mode of adjusting the laser output (energy quantity) employed in the welding process of an embodiment of the present invention and an explanatory drawing illustrating schematically the shape of the welding beam formed by the laser output.

FIG. 5 is a partial cross-sectional view explaining one mode of arranging a seal plate on a case.

FIG. 6 is a partial cross-sectional view explaining another mode of arranging a seal plate on a case.

### DETAILED DESCRIPTION OF THE INVENTION

As described in detail in the following embodiments, an outline of the longest side of the peripheral wall of the case may extend along a straight line. Also, the top surface of the peripheral wall may extend along a flat surface. In this case, a bottom surface of the seal plate may also extend along the flat surface.

A scanning speed of the energy beam may be maintained substantially constant while traveling along each side. Even if the scanning speed is maintained constant, deep welded depth may be obtained by strengthening the energy beam while radiating the position where the peripheral wall is thick. On the other hand, shallow welded depth may be obtained by weakening the energy beam while radiating the position where the peripheral wall is thin.

It may be preferred that the scanning and radiating step is repeatedly performed for each side. Specifically it is preferred that the case and the seal plate are moved with respect to the energy beam fixed at a predetermined position. A simple device for moving the case and the seal plate may be adapted for performing the method.

It may be preferred that the energy beam is a combination of a pulse wave laser beam and a continuous wave laser beam.

Typically, the cross section of an outline of the peripheral wall of the case is rectangular, and the thickness of the peripheral wall is thick at middle portions of the pair of long sides, thin at distal end portions of the pair of long sides and uniform along the pair of short sides. It is also preferred that the top surface of the peripheral wall and the bottom surface of the seal plate are flat.

It is preferred that the seal plate and case be fixed to a movable work stand and that the contacting line of the seal plate and case (a line where the contact surface of the seal plate and case is exposed to the outside) passes through a spot of the energy beam. An expensive and precision optical device can be fixed.

If the upper surface of the peripheral wall and lower surface of the seal plate extend along a flat surface, the contacting surface of the seal plate and the case is a flat surface and the contacting line of the seal plate and the case is a straight line. The movement path of the work stand may be a straight line.

It is preferred that the scanning speed is maintained constant, and the energy intensity of the energy beam is changed, instead of changing the scanning speed. In this case, control is facilitated.

The energy beam is preferably a combination of a pulse wave laser beam and a continuous wave laser beam. If a combination of a pulse wave laser beam and a continuous wave laser beam is used, the weld of the case and seal plate can be reliably maintained in an air-tight state.

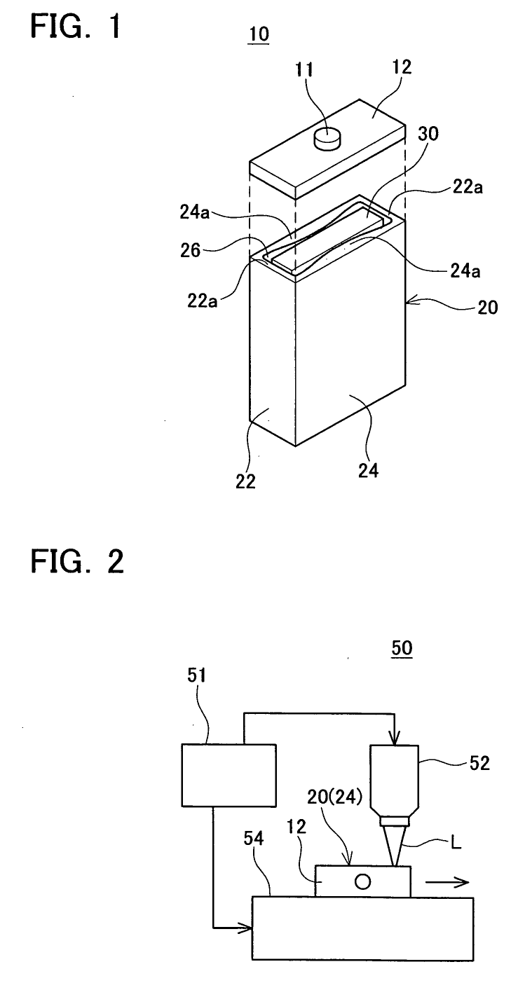

FIG. 1 illustrates schematically the external appearance of a sealed nickel-metal hydride secondary battery 10 that is the battery of the present embodiment. This battery 10 generally comprises an electrode unit 30, an angular case 20 having an open section 26 (formed from a Ni-plated steel sheet) formed therein for accommodating the electrode unit 30, and a rectangular seal plate 12 (Ni-plated steel sheet) installed above the open section 26 of the case 20 and closing the open section. The electrode unit 30 comprises a positive electrode comprising nickel hydroxide, a negative electrode comprising a hydrogen absorbing alloy, and a separator. An electrolyte is introduced together with the electrode unit 30 into the case 20. In the present embodiment, an aqueous alkali solution comprising potassium hydroxide as the main component is introduced as the electrolyte.

The rectangular case 20 is in the form of a rectangular parallelepiped with flat outer surfaces and comprises peripheral walls 22, 24 forming the open section 26 of a generally rectangular shape. The peripheral walls include a pair of long peripheral walls (long-side peripheral walls) 24 corresponding to long sides of the open section 26 and a pair of short peripheral walls (short-side peripheral walls) 22 corresponding to short sides of the open section 26. The rectangular case 20 comprises a closed bottom section. The rectangular case 20 of the present embodiment is in the form of a rectangular parallelepiped, the lateral width of the long-side peripheral wall 24 is 85 mm, the lateral width of the short-side peripheral wall 22 is 30 mm, and the height from the case bottom surface to the open section is 100 mm. The shape of the rectangular case can be changed to match the shape of the battery.

As shown in FIG. 1 and below-described FIG. 4, the thickness of the long-side peripheral walls 24 of the case 20 is not constant. As viewed from above the open section 26, the thickness is large in the middle portion and changes to decrease toward both ends, thereby providing for a hill-like shape. In the present embodiment, the thickness changes within a range of 0.3-0.4 mm. For example, the thickness is 0.36-0.37 mm in the middle portion of the cross section of the open section of the peripheral wall 24 and 0.34-0.35 in the corner, which is the thinnest section, and in the vicinity thereof. Because of such variation in thickness, the case 20 of the present embodiment has high resistance to pressure and the middle portion thereof in the width direction of the peripheral wall 24 hardly deforms even when the pressure inside the case 20 rises after the open section 26 has been sealed. Furthermore, in FIG. 1, the thickness of the peripheral walls 22, 24 and thickness variation are somewhat exaggerated; this variation in thickness cannot be visually detected. The thickness of the short-side peripheral walls 22 is substantially constant (about 0.35 mm).

On the other side, the seal plate 12 corresponding to the case 20 is a lid member in the form of a rectangular parallelepiped (about 85 mm×30 mm×2 mm) having the same outline and the external outline of the cross section of the case 20. As shown in FIG. 1, the seal plate 12 is disposed on the upper surfaces 22a, 24a of the peripheral walls 22, 24 forming the open section 26 of the case 20. At this time, the corner sections of the seal plate 12 match the corner sections of the case 20. As shown in the figure, a positive electrode terminal for electric connection to a positive electrode (not shown in the figure) of the electrode unit 30 is provided in the seal plate 12. The positive electrode terminal 11 is provided so as to be electrically insulated from the body of the seal plate 12. The body of the case 20 constitutes the negative electrode terminal of the battery 10 of the present embodiment.

The battery 10 can be manufactured by welding the above-described case. 20 and seal plate 12 by using a laser welding apparatus of a general structure such as shown schematically in FIG. 2.

The welding apparatus 50 shown in FIG. 2 is an apparatus for irradiating a material that is to be welded with a so called hybrid laser beam, this apparatus comprising a YAG laser generator of a pulse generation system and a CW semiconductor laser generator of a continuous generation system. In general, the welding apparatus comprises a laser emission device 52 comprising the two laser generators; a flux collector; an XYZ stage 54, which is a work stand for fixing the material to be welded (work); and a control unit (microcomputer) 51 capable of controlling both the output of the laser generators and the movement of the XYZ stage 54.

More specifically, the material to be welded, in a state where the seal plate 12 is disposed on the open section 26 of the angular case 20, is fixed to a fixing jig (not shown in the figure) on the XYZ stage 54, and a hybrid laser beam L comprising an YAG pulse laser beam and a CW continuous laser beam is radiated so that the laser focal point is on the boundary portion of one side surface (in FIG. 2, one long-side peripheral surface 24) of the case 20 and the seal plate 12. At this time, as shown in FIG. 2 and FIG. 3-1, the XYZ stage 54 is caused to move linearly with a constant speed in one prescribed direction (for example, only in the X axis direction) by a drive signal from the control unit 51, and the laser irradiation position (that is, the welding site) is caused to move with a constant speed from one end portion (corner) to the other end portion (corner). Welding efficiency is good if welding is conducted while moving the laser irradiation position linearly with a substantially constant speed. As long as laser irradiation is conducted, while moving the irradiation position with a constant speed from one end portion (corner) to the other end portion (corner), the start point and stop point of this laser irradiation may be set in locations outside the case 20. The above-described operations complete the welding of the boundary of the long side surfaces 24 and sealed plate 12.

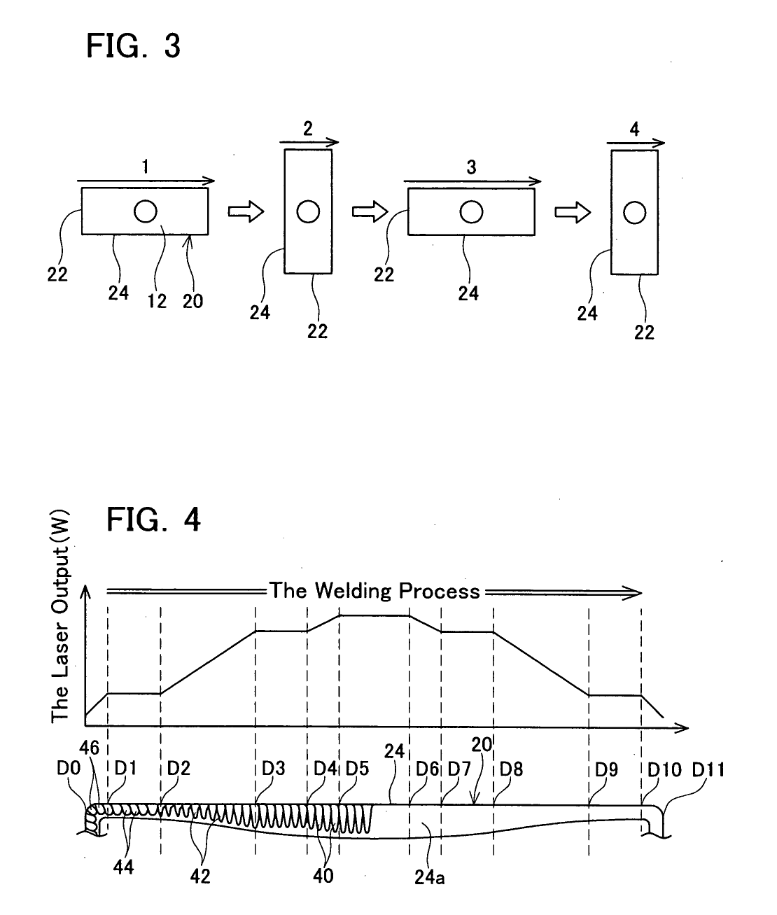

Further, as shown in FIG. 3-2, the orientation of the case 20 and seal plate 12 on the XYZ stage 54 is rotated 90°, and the case and seal plate are fixed again, the XYZ stage 54 is moved appropriately so that the laser irradiation position and laser focal point match the boundary section of the seal plate 12 and one side surface (here, one short-side peripheral surface 22) that is anew taken as a laser irradiation surface. Then, as described hereinabove, the laser irradiation position (welding site) is moved from one end portion (corner) to another end portion (corner) along the boundary line of the short-side surface 22 and seal plate 12 and welding is conducted along the boundary of the short-side surface 22 and seal plate 12.

Then, as shown in FIG. 3-3 and 3-4, welding is also similarly conducted by moving the laser irradiation position (welding site) with a constant speed from one end portion (corner) to another end portion (corner) along the boundary line with respect to other two side surfaces (that is, the remaining long-side peripheral wall 24 and short-side peripheral wall 22), while changing the orientation of the case 20 and seal plate 12 on the XYZ stage 54 90° and appropriately moving the XYZ stage 54 so as to match the laser focal point with the laser irradiation position. Welding of all the four side surfaces of the seal plate 12 and case 20 in the form of a rectangular parallelepiped, that is, welding along the entire perimeter of the case 20, is thus completed.

As described above, in the present embodiment, the laser irradiation position (welding site) is moved from one end portion (corner) to another end portion (corner section) by actuating the XYZ stage 54 in one direction (X axis direction). As a result, the adjustment of the laser focal point and the movement of the laser irradiation position can be implemented accurately and in an easy manner, regardless of laser irradiation from the case side.

Furthermore, the adjustment of the laser focal point and movement of the laser irradiation position may be also conducted by moving the laser emission device on the stage 54, together with or instead of moving the XYZ stage 54.

In the above-described welding process, the energy output (here, the laser output) in the present embodiment is adjusted so that the welding penetration depth in the middle portion of the pair of long-side peripheral walls 24 is larger than the welding penetration depth in the vicinity of both ends thereof. More specifically, from one corner, which is a portion with the smallest thickness, to the middle portion, which is the thickest portion, laser welding is conducted, while increasing the laser output continuously or in a stepwise manner correspondingly to the variation of thickness in the long-side peripheral wall 24. Conversely, from the middle portion to the other corner, laser welding is conducted while decreasing the laser output continuously or in a stepwise manner. This will be explained with reference to FIG. 4.

As shown in FIG. 2 and FIG. 3-1, the long-side peripheral wall 24 is disposed facing the laser emission device 52 in the prescribed position on the stage 54, and the stage 54 is moved in the prescribed direction (for example, the X axis direction) from one end portion (corner) to the other end portion (corner) along the boundary line (also referred to hereinbelow as “welding line”) of the peripheral wall 24 and seal plate 12 at a prescribed speed (e.g., 45 mm/sec.). At this time, the laser output value is controlled correspondingly to the movement distance of the laser irradiation position (that is, the movement distance Dx along the welding line where one corner of the long-side peripheral wall 24 is disposed at a distance D0), based on an output program that has been inputted into the control unit 51 in advance according to the thickness variation of the long-side peripheral wall 24. The laser output value is adjusted so that the welding penetration depth in substantially the middle portion of the boundary line of the long-side peripheral wall 24 and seal plate 12 becomes relatively large, whereas the welding penetration depth close to two ends (that is, close to corners of the case) of the boundary line becomes relatively small.

More specifically, first, laser irradiation is conducted while continuously increasing the output value from 0.91×E (W) to 0.94×E (W) as the laser irradiation position moves from one end portion D0 to the point D1 (for example, the location at a distance of 5 mm from the end portion D0) corresponding to the step of passing through the corner, where the maximum output value in the laser welding apparatus 50 is taken as E (for example, 440 W). Then, from the point D1 to the point D2 (for example, the location at a distance of 15 mm from the end portion D0) where the thickness practically does not change, laser irradiation is conducted while maintaining the output value at 0.94×E (W). From the point D2 to the point D3 (for example, the location at a distance of 30 mm from the end portion D0) where the thickness gradually increases, laser irradiation is conducted while increasing the output value from 0.94×E (W) to 0.99×E (W). Then, from the point D3 to the point D4 (for example, the location at a distance of 36 mm from the end portion D0) where the thickness practically does not change, laser irradiation is conducted while maintaining the output value at 0.99×E (W). Then, from the point D4 to the point D5 (for example, the location at a distance of 40 mm from the end portion D0) where the thickness further increases, laser irradiation is conducted while continuously increasing the output value from 0.99×E (W) to 1.00×E (W). Then, from the point D5 in the middle portion with the largest thickness in the welding line to the point D6 (for example, the location at a distance of 45 mm from the end portion D0), laser irradiation is conducted while maintaining the output value at 1.00×E (W). Then, from the point D6 to the point D7 (for example, the location at a distance of 49 mm from the end portion D0) where the thickness gradually decreases, laser irradiation is conducted while continuously decreasing the output value from 1.00×E (W) to 0.99×E(W). Then, from the point D7 to the point D8 (for example, the location at a distance of 55 mm from the end portion D0) where the thickness practically does not change, laser irradiation is conducted while maintaining the output value at 0.99×E(W). Then, from the point D8 to the point D9 (for example, the location at a distance of 70 mm from the end portion D0) where the thickness gradually decreases, laser irradiation is conducted while continuously decreasing the output value from 0.99×E (W) to 0.94×E(W). Then, from the point D9 to the point D10 (for example, the location at a distance of 80 mm from the end portion D0) where the thickness practically does not change, laser irradiation is conducted while continuously maintaining the output value at 0.94×E(W). Finally, from the point D10 to another end portion D11 via the corner, laser irradiation is conducted while continuously decreasing the output value from 0.94×E (W) to 0.91×E (W).

With such adjustment of laser output value, as shown in the lower portion of FIG. 4, welding beads 40, 42, 44, 46 (penetration regions) where the penetration depth varies correspondingly to the thickness variation of the peripheral wall 24 are formed on the boundary between the peripheral wall 24 and seal plate 12. In the present embodiment, the penetration depth reaching about 70-90% of the thickness from the surface (lower irradiation surface) of the peripheral wall 24 is realized along the entire welding beads 40, 42, 44, 46.

In the present embodiment, as described hereinabove, the welding penetration depth is varied by adjusting the laser output value and the emission spacing of YAG laser pulses is constant. As a result, as shown in FIG. 4, in the sealed battery case manufactured by the method of the present embodiment, the welding beads 40, 42, 44, 46 with the waveform reflecting the constant pulse spacing are observed, as viewed from the cross section of the welding zone.

As described above, changing the laser output (energy) value correspondingly to the change in the thickness of the long-side peripheral wall 24 makes it possible to increase pressure resistance of the case 20 (in particular, welded zone) against the increase in the internal pressure after sealing. Furthermore, if the laser irradiation is moved linearly along the welding line and welding intensity (that is, penetration depth) is adjusted by appropriately changing the laser output in the prescribed position, as in the present embodiment, then energy beam welding contributing to the increase in pressure resistance can be conducted easily and effectively, without using a special apparatus.

Furthermore, changing the laser output (energy) value correspondingly to the change in the thickness of the long-side peripheral wall 24 makes it possible to maintain heat efficiency along the entire long-side peripheral wall, regardless of the thickness change, and to reduce or prevent the occurrence of welding defects.

Furthermore, decreasing the laser output in the corner (that is, in the interval from D0 to D1 shown in FIG. 4 and in the interval from D10 to D11), as in the present embodiment, makes it possible to reduce or prevent the occurrence of welding defects in the corner where the laser irradiation from the surface of the long-side peripheral wall 24 and laser irradiation from the short-side peripheral wall 22 overlap.

In the present embodiment, the thickness of the short-side peripheral wall was constant, but from the standpoint of reducing or preventing the occurrence of welding defects in the corners, it is preferred that the laser output value in the corners decrease, in the same manner as in the long-side peripheral walls 24, with respect to that in the middle portion of the short-side peripheral wall 22. For example, the above-described output control from D0 to D1 shown in FIG. 4, subsequent output control from D1 (D9) to D2 (D10), and then output control from D10 to D11 may be also employed in the welding process of the boundary of the short-side peripheral wall 22 and seal plate 12.

The preferred mode for carrying out the present invention was explained above based on the embodiments thereof, but they are merely illustrative and place no limitation on the claims. The technology described in the claims also includes modifications and variations of the above-described examples of implementation modes. For example, the angular case of the above-described embodiment is in the form of a rectangular parallelepiped, but the present invention is not limited to the case in the form of a rectangular parallelepiped or cube, and is also applicable to angular cases in which the outer surface side of the cross section of the open section of the peripheral wall constituting the peripheral edge of the open section of the polygonal case is linear, and which have a plurality of peripheral walls constituting the periphery in a frame-like fashion.

A specific feature of the present manufacturing method is that the seal plate capable of covering the open section is disposed in a position of closing the open section of the rectangular case accommodating the electrode unit and welding is conducted from the side of the case in the boundary sections thereof. Other features (for example, materials used and other processes) are similar to the conventional methods for battery manufacture and no specific limitation is placed thereon.

The battery manufactured by the present manufacturing method may be any battery comprising a weldable angular case of a sealed type. Therefore, no specific limitation is placed on the type and structure of the battery.

In the above-described embodiment, a Ni-plated steel sheet was used for the angular case, but this is not limiting. In the angular case, at least the portions contiguous to the seal plate may be composed of a weldable material. In addition to the Ni-plated steel sheet, a metal sheet such as aluminum sheet or an alloy sheet such as a stainless steel sheet can be used for the angular case.

On the other hand, the seal plate may be from a material weldable with the case of the above-described materials, and no limitation is placed on the material of the seal plate. The material identical to that of the case may be employed for the seal plate.

With the present manufacturing method, welding of the seal plate and case may be implemented from the case side. Therefore, no limitation is placed on the mode of arranging the seal plate on the open section of the case.

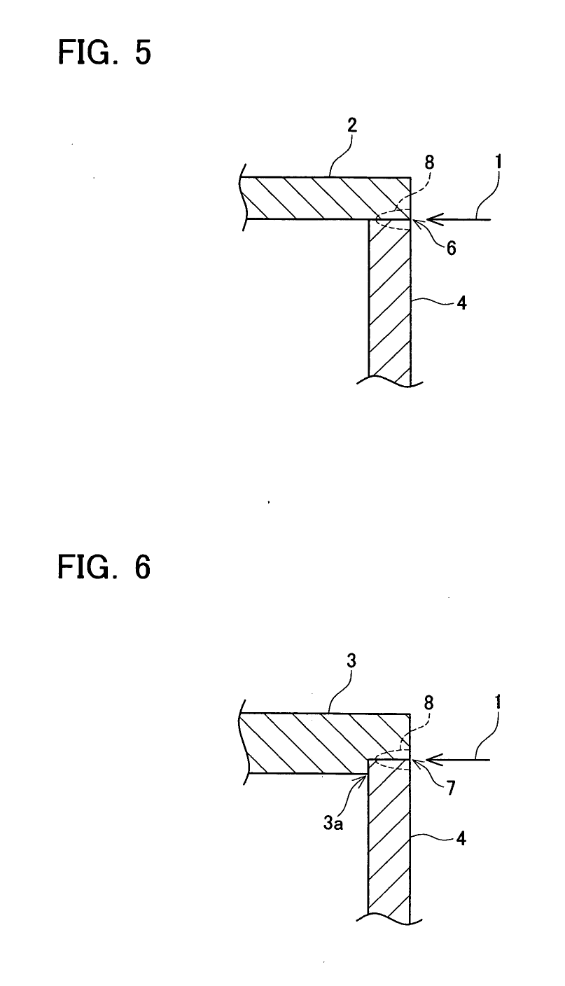

FIG. 5 illustrates schematically an example of a partial cross-sectional view explaining one mode of arranging the seal plate on the open section of the case. As shown in FIG. 5, a lid-like seal plate 2 with an outer diameter equal to the outer diameter of the case is placed on the flat end surface of the peripheral wall 4 of the case. As a result, a flat boundary section 6 that can be easily welded from the case side is formed between the seal plate 2 and peripheral wall 4 of the case (that is, the end surface constituting the periphery of the open section). The arrow denoted by the reference symbol 1 in FIG. 5 indicates the energy beam (laser beam, etc.) irradiating the boundary section 6. The dot line denoted by the reference numeral 8 indicates schematically the welding bead (penetration region) formed in the boundary portion 6 by energy irradiation.

FIG. 6 illustrates schematically another mode of arranging the seal plate on the case. In the mode shown in FIG. 6, a seal plate 3 is employed, which has a step 3a formed in the outer peripheral section, of the lower surface. When such seal plate 3 is used, the seal plate 2 can be placed on the peripheral wall 4 of the case, while engaging the end portion of the peripheral wall 4 of the case with the step 3a. This method also forms a flat boundary section 7 between the seal plate 3 and the peripheral wall 4 of the case. Furthermore, in this mode, alignment during arrangement of the seal plate 3 is facilitated by the formation of the step 3a.

Furthermore, the outer shape of the seal plate may be larger than the outer shape of the case to the degree enabling welding with the case.

Means capable of adjusting the output quantity of irradiation energy may be used as the energy beam welding means. Examples of energy beam welding means include other laser welding methods or electron beam welding method in addition to the above-described YAG laser welding method. With a variety of laser welding methods, welding is possible in the air and can be conducted in an easy manner. With welding methods using a YAG laser or a CO2 laser as a heat source, the output adjustment of irradiation energy can be easily conducted by controlling the output of laser generator.

In the above-described embodiment, the so-called hybrid laser welding combining a pulse wave laser and a continuous wave laser was employed, but such welding is not limiting. With the present method, a typical pulse wave laser welding may be employed.

Welding of the angular case and seal plate may be implemented by using a generally employed welding apparatus for energy beam welding and no specific limitation is placed thereon. Furthermore, no limitation is place on the drive method of the welding apparatus during welding operation. In the above-described embodiment, a welding apparatus was employed in which a movable work stand (XYZ stage) capable of moving in the horizontal direction and vertical direction was combined with a fixed laser flux collector. In the above-described embodiment, a linear welding treatment was implemented by moving the XYZ stage. In accordance with the present invention, welding can be also implemented with a welding apparatus combining a fixed work stand and a movable laser flux collector. With such configuration, the linear welding treatment can be implemented by moving the movable laser flux collector. Furthermore, a flux collector movable in the vertical direction may be combined with the work stand movable in the horizontal direction. With any configuration, laser irradiation can be conducted from the side of the case after correctly arranging the seal plate on the open section of the case.

Technical features explained in the present specification or illustrated by the appended drawings demonstrate technical utility individually or in various combinations thereof and are not limited to the combinations described in the claims at the time of filing the application. Furthermore, the technology described by way of examples in the present specification or appended drawings attains multiple objects at the same time and demonstrates technical utility by itself by attaining one of those objects.

What is claimed is:

1. A method of manufacturing a battery comprising steps of:
installing an electrode unit within a case having a closed bottom and an opened top, wherein the cross section of a peripheral wall defining the opened top is substantially polygon, and a thickness of the peripheral wall is thick at middle portion and thin at distal end portions of a side that is at least longest among sides defining the polygon;
contacting a seal plate against a top surface of the peripheral wall of the case to close the opened top of the case; and
scanning and radiating an energy beam along the contacting line between the peripheral wall of the case and the seal plate continuously, wherein the energy beam having large energy is radiated at a position where the peripheral wall is thick and the energy beam having small energy is radiated at positions where the peripheral wall is thin.

2. A method of claim 1, wherein an outline of the longest side extends along a straight line.

3. A method of claim 1, wherein the top surface of the peripheral wall extends along a flat surface.

4. A method of claim 1, wherein a scanning speed of the energy beam is maintained substantially constant while traveling along each side.

5. A method of claim 4, wherein the energy beam is strengthened while radiating the position where the peripheral wall is thick and the energy beam is weakened while radiating the position where the peripheral wall is thin.

6. A method of claim 4, wherein the scanning and radiating step is repeatedly performed for each side.

7. A method of claim 4, wherein the case and the seal plate are moved with respect to the energy beam fixed at a predetermined position.

8. A method of claim 1, wherein the energy beam is a combination of a pulse wave laser beam and a continuous wave laser beam.

9. A battery comprising:
an electrode unit;
a case installing the electrode unit, and having a closed bottom and an opened top, wherein the cross section of a peripheral wall defining the opened top is substantially polygon, and a thickness of the peripheral wall is thick at middle portion and thin at distal end portions of a side that is at least longest among sides defining the polygon; and
a seal plate welded to a top surface of the peripheral wall of the case;
wherein welded depth between the peripheral wall of the case and the seal plate is deep at a position where the peripheral wall is thick and shallow at positions where the peripheral wall is thin.

10. A battery of claim 9,
wherein the cross section of an outline of the peripheral wall is rectangular, and the thickness of the peripheral wall is thick at middle portions of the pair of long sides, thin at distal end portions of the pair of long sides and uniform along the pair of short sides.

11. A battery of claim 10,
wherein a top surface of the peripheral wall and a bottom surface of the seal plate are flat.
